(19) United States
(12) Patent Application Publication
(10) Pub. No.: US 2011/0185275 A1
(43) Pub. Date: Jul. 28, 2011

(54) DEVICE AND METHOD FOR UPDATING STRUCTURED INFORMATION

(75) Inventors: Jihun Cha, Daejeon (KR); Injae Lee, Daejeon (KR); Young-Kwon Lim, Seoul (KR); Han Kyu Lee, Daejeon (KR); Jin Woo Hong, Daejeon (KR)

(73) Assignees: ELECTRONICS AND TELECOMMUNICATIONS RESEARCH INSTITUTE, Daejeon (KR); NET & TV INC., Seoul (KR)

(21) Appl. No.: 13/121,077

(22) PCT Filed: Sep. 25, 2009
(86) PCT No.: PCT/KR2009/005503

§ 371 Date: Mar. 25, 2011

Related U.S. Application Data
(60) Provisional application No. 61/100,414, filed on Sep. 26, 2008.
(60) Provisional application No. 61/104,347, filed on Oct. 10, 2008.

(30) Foreign Application Priority Data
Sep. 21, 2009 (KR) 10-2009-0089066

(51) Int. Cl. G06F 17/00

(52) U.S. Cl. 715/234

(57) ABSTRACT

Disclosed is a device and method of updating Structured Information (SI). The device and the method may define a standard for updating SI based on information described in Presentation Information (PI) and may update the SI based on the defined standard.

### TECHNICAL FIELD

The present invention relates to a device and method of updating structured information based on presentation information.

### BACKGROUND ART

There have been proposed several approaches related to an updating of Structured Information (SI) from Presentation Information (PI).

A first approach is a programmatic approach utilizing a script, and a second approach is a declarative approach defining additional information in the presentation.

The programmatic approach utilizing the script may be a very useful tool since the approach provides nearly unlimited methods for accessing the structured information.

However, the programmatic approach creates a burden due to use of a predetermined script language and requires, from a contents writer, more than a certain level of knowledge, and thus, producing Lightweight Application Scene Representation (LASeR) content that is utilized for the presentation and modification of the structured information may be difficult. Also, the programmatic approach may not utilize an advantage of LASeR being a declarative language.

Here, LASeR, which is a multimedia contents standard appropriate for a low specification mobile device such as a portable phone, may provide, through LASeR contents or an LASeR based system, a service where a wireless portal, a mobile TV, music, a personal service, and the like are combined, and may be capable of embodying a realistic motion effect and an interactive Interface.

A declarative approach mechanism is proposed based on a Moving Pictures Experts Group (MPEG) standard, and updating of the SI structured from the PI is required. When a user modifies a setting in the PI, a result of the modification may need to be stored in a predetermined format.

Accordingly, there is a need for a new element that updates the SI through the PI. Therefore, a currently existing presentation standard (LASeR) may be extended to propose a technology that effectively updates the SI.

### DISCLOSURE OF INVENTION

### Technical Problem

An aspect of the present invention provides a device and a method of updating Structured Information (SI), the device and the method extracting information described in Presentation Information (PI), updating the SI based on the described information, and modifying the SI based on the PI.

### Solution to Problem

According to an aspect of an exemplary embodiment, there is provided an updating device of updating structured information, including updating the structured information according to an attribute of a type.

Also, the updating device updates the structured information based on information described in scene representation data.

Also, the updating device updates the structured information based on an attribute of a type included in an externalUpdate element that supports an update of the structured information.

Also, the externalUpdate element includes an ‘xlink:href’ attribute indicating an element that is replaced, inserted, or deleted by using a mpeg-pmsi( ).

Also, the externalUpdate element includes a ‘type’ attribute indicating one type among a replacement, an insertion, and a deletion.

Also, the externalUpdate element includes an ‘attributeName’ attribute defining a name of an attribute that is replaced or inserted.

Also, the externalUpdate element includes an ‘index’ attribute defining an index of a child node that is replaced, inserted, or deleted.

Also, the externalUpdate element includes an ‘operandElementId’ element defining an identification (ID) of an element from which a replacement or an insertion is taken.

Also, the externalUpdate element includes an ‘operandAttributeName’ attribute defining a name of a field from which a replacement or an insertion is taken.

Also, the externalUpdate element includes a ‘value’ attribute indicating a value that is replaced or inserted.

Also, the externalUpdate element includes an lsr:updateInterval attribute setting an update interval of the structured information. Here, when a value of the lsr:updateInterval is set to “none”, the structured information is updated once, and when the value of the lsr:updateInterval is set to “free”, the structured information is updated at an arbitrary interval, and when the value of the lsr:updateInterval is a “<Clock-value>” being greater than “0”, the structured information is updated at “<Clock-value>” intervals.

Also, the scene representation data addresses a text included in the structured information by using a SVG tref as a child element of “SVG textArea”, and determines a character of the text by using the SVG textArea to provide text wrapping.

Also, the scene representation data provides a LASeR taref element that addresses textual contents, as a child element of the SVG textArea element. Here, the LASeR taref element has an xlink:href attribute indicating a referenced element or a referenced attribute.

According to another aspect of an exemplary embodiment, there is provided a method of updating structured information, including extracting information described in scene representation data, and updating the structured information based on the described information according to an attribute of a type.

### Advantageous Effects of Invention

According to an exemplary embodiment of the present invention, there is provided a device and a method of updating Structured Information (SI), the device and the method extracting information described in Presentation Information (PI), updating the SI based on the described information, and modifying the SI based on the PI.

### BRIEF DESCRIPTION OF DRAWINGS

FIG. 1 illustrates a mechanism that updates Structured Information (SI) according to an embodiment of the present invention;

FIG. 2 illustrates source code to replace a predetermine value in an SI according to an embodiment of the present invention;

FIG. 3 illustrates a source code to replace a predetermined attribute in an SI according to an embodiment of the present invention;

FIG. 4 illustrates source code to insert a predetermined element to an SI according to an embodiment of the present invention;

FIG. 5 illustrates a source code of Presentation Information (PI) to update an SI at predetermined intervals according to an embodiment of the present invention; and

FIGS. 6 and 7 illustrates source code of PI to determine a character with respect to a text and to provide a text wrapping according to an embodiment of the present invention.

### MODE FOR THE INVENTION

Although a few exemplary embodiments of the present invention have been shown and described, the present invention is not limited to the described exemplary embodiments, wherein like reference numerals refer to the like elements throughout.

In a Presentation and Modification of Structured Information (PMSI) scheme, a mechanism of updating Structured Information (SI) based on a result of a presentation is required. As an example, when a user selects a preferred item, such as a genre, a color, a location, and the like from a presented scene, the SI including user preference data may need to be updated based on preference characteristics information of the user.

Accordingly, example embodiments of the present invention may update the SI from scene representation data (presentation information) according to information described in a scene. In this instance, the SI may be metadata specifying an item to be represented. The SI may be expressed by Moving Pictures Expert Group (MPEG)-21 Digital Item Declaration (DID) standard, and an MPEG-7 standard, and also, may be structured information constructed by the user. Also, the scene representation data may be a scene description scheme indicating how to represent the SI. The scene representation data may be expressed by Binary Format For Scenes (BIFS), and Lightweight Application Scene Representation (LASeR), and, depending on embodiments of the present invention, a LASeR format may be applicable.

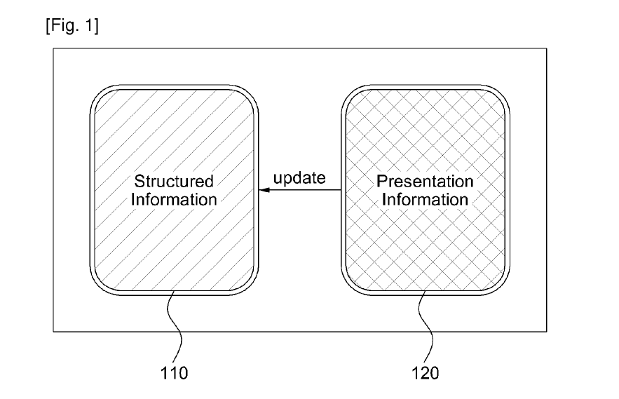

An example of an update mechanism proposed by embodiments of the present invention will be described in detail with reference to FIG. 1.

FIG. 1 illustrates a mechanism that updates SI according to an embodiment of the present invention.

Referring to FIG. 1, the SI is updated from presentation data (scene representation data) according to information described in a scene. As an example, the SI is updated to reflect an item described in Presentation Information (PI) according to a change of the scene.

With respect to the above description, the present invention discloses embodiments as follows.

(a) defining an externalUpdate element to modify elements or attributes of SI

(b) using an SVG tref element for referencing textual contents of an SVG text or an SVG textArea

(c) using an LASeR taref element for referencing textual contents of an SVG textArea

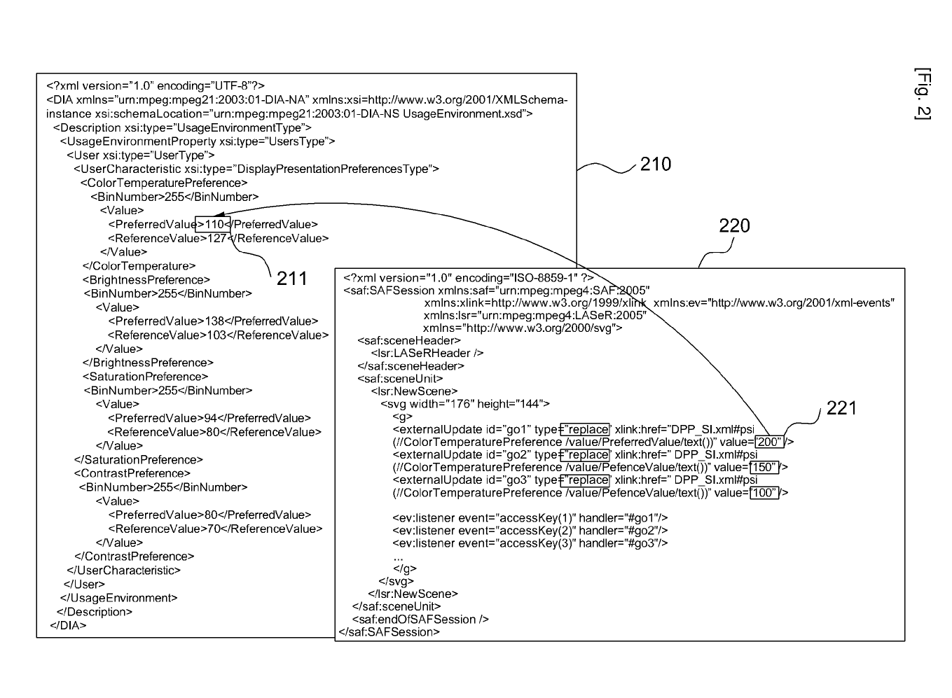

Hereinafter, embodiments of the present invention will be described in detail with reference to FIGS. 2 through 6.

<LASeR externalUpdate Element>

(1) proposing an externalUpdate element that may modify a part of the SI, may insert additional information to the SI, or may delete a part of the SI.

(2) Semantics

The externalUpdate element may support updating of the SI and may have three types: “replace”, “insert”, and “delete”. Accordingly, a part of the SI may be replaced with new elements or new values, the new elements or the values may be inserted to the SI, or a part of the SI may be deleted, according to one of the provided three types.

(3) Attributes

(a) xlink:href

An xlink:href attribute may indicate an element or an attribute to be replaced, inserted, or deleted by conjunctly using mpeg-pmsi( ).

(b) type

A type attribute may have one type of “replace”, “insert”, and “delete”. Here, when the type attribute is the “replace”, an existing element/attribute may be replaced with a new element/attribute. When the type attribute is the “insert”, the new element/attribute may be inserted to the SI. Also, when the type attribute is the “delete”, the existing element/attribute of the SI may be deleted.

(c) attributeName

An attributeName attribute may define a name of an attribute that is replaced or inserted in the SI.

(d) index

An index attribute may define an index of a child node that is replaced, inserted, or deleted. That is, the child node to be replaced, inserted, or deleted may be determined based on the index. Here, in an absence of the index attribute, the child node may be inserted or replaced at the end of a child list. Also, the child node defined by an index may need to be an element existing in the SI.

(e) operandElementId

An operandElementId attribute may define an identification (ID) of an element from which replacement or insertion is taken. In this instance, the operandElementId may need to be an element existing in the PI.

(f) operandAttributeName

An operandAttributeName attribute may define a name of a field (attribute) from which replacement or insertion is taken. In this instance, the operandAttributeName may need to be a field (attribute) existing in the PI.

(g) value

A value attribute may indicate a value to be replaced or inserted.

(h) lsr:updateInterval

An lsr:updateInterval attribute may define an update interval of the SI. Here, when a value of the lsr:updateInterval attribute is set to “none”, the SI is updated once, and when the value of the lsr:updateInterval attribute is set to “free”, the SI is updated at an arbitrary interval, and when the value of the lsr:updateInterval attribute is a “<Clock-value>” being greater than “0”, the SI is updated at “<Clock-value>” intervals. Hereinafter, an update interval mechanism will be described in detail.

<Update Interval Mechanism>

### (1) Proposal

A mechanical process may be provided to update the SI. Accordingly, the lsr:updateInterval attribute, may be proposed.

An updateInterval attribute indicates an update interval with respect to all elements and attributes included in a corresponding element. In this instance, the updateInterval attribute may be one of “none”, “free”, and “<Clock-value>”.

First, when the updateInterval attribute is “none”, the “none” value may indicate that the referred Structured Information shall be modified only once. That is, whether the scene representation data is updated may not be determined again.

When the updateInterval attribute is “free”, the “free” value may indicate that whether the scene representation data is updated is determined at an arbitrary interval. That is, the “free” value does not indicate that an author of the presentation sets an updating interval, but indicates that the updated is determined at the arbitrary interval according to discretion of a manufacturer of the device. Accordingly, whether the scene representation data is updated is determined at the arbitrary interval according to the discretion of a manufacturer of the device, and the SI may be updated with an item for updating.

When the updateInterval attribute is “<Clock-value>”, the “<Clock-value>” indicates that the updated is determined at a predetermined “<Clock-value>” interval. In this instance, the “<Clock-value>” value may need to be greater than 0. That is, when the updateInterval attribute is “<Clock-value>”, the author of the presentation may set an interval for reasonably meaningful value for the update.

### (2) Example

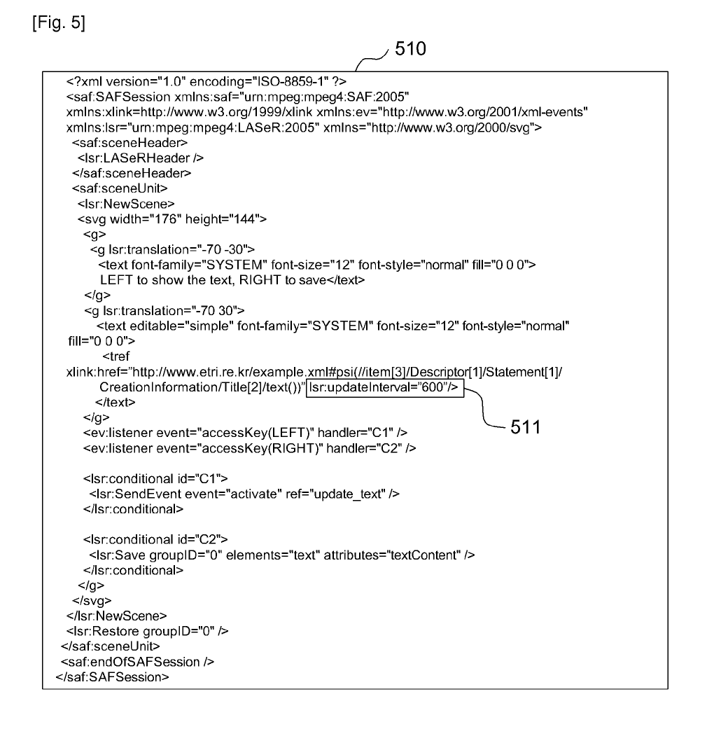

FIG. 5 illustrates a source code of PI 510 to update an SI according to an embodiment of the present invention.

Referring to FIG. 5, lsr:updateInterval for updating SI is defined as “600” 511, and thus, it is a case that the lsr:updateInterval attribute is “<Clock-value>”, thereby the SI may be updated after every 600 seconds.

### (3) Example

FIG. 2 illustrates source code to replace a predetermined value in an SI according to an embodiment of the present invention.

Referring to FIG. 2, a value in the SI 210 may be replaced based on a “replace” attribute in the PI 220. As illustrated in FIG. 2, an existing value “110” 211 of ColorTemperaturePreference in the SI 210 may be replaced with a value “200” 221 in the PI 220 according to the value “200” 221.

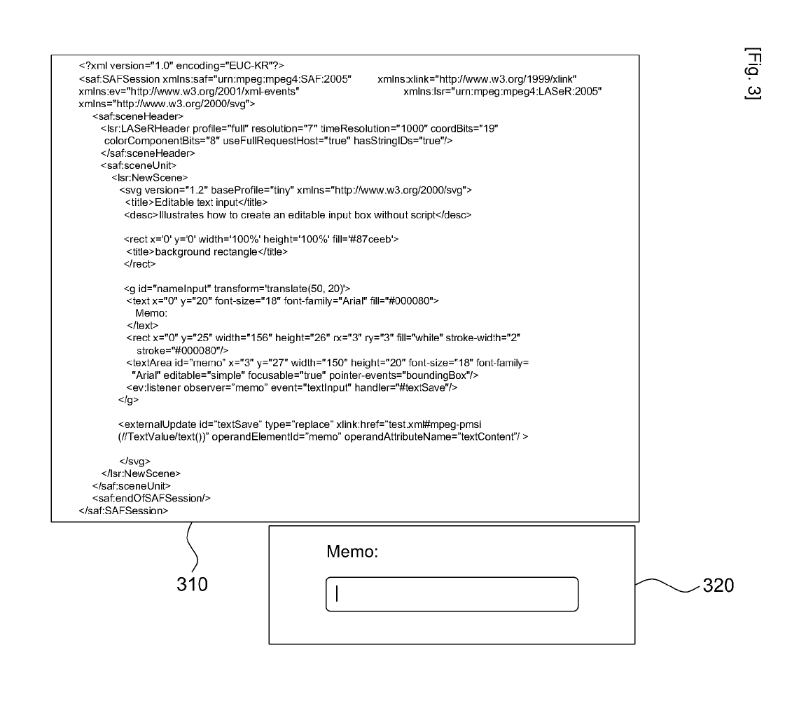

FIG. 3 illustrates a source code to replace a predetermined attribute in an SI according to an embodiment of the present invention.

Referring to FIG. 3, when a text and the like are inputted through a “memo” area 320 in a scene based on a “replace” attribute in the PI 310, the predetermined text in the SI may be replaced based on the inputted text.

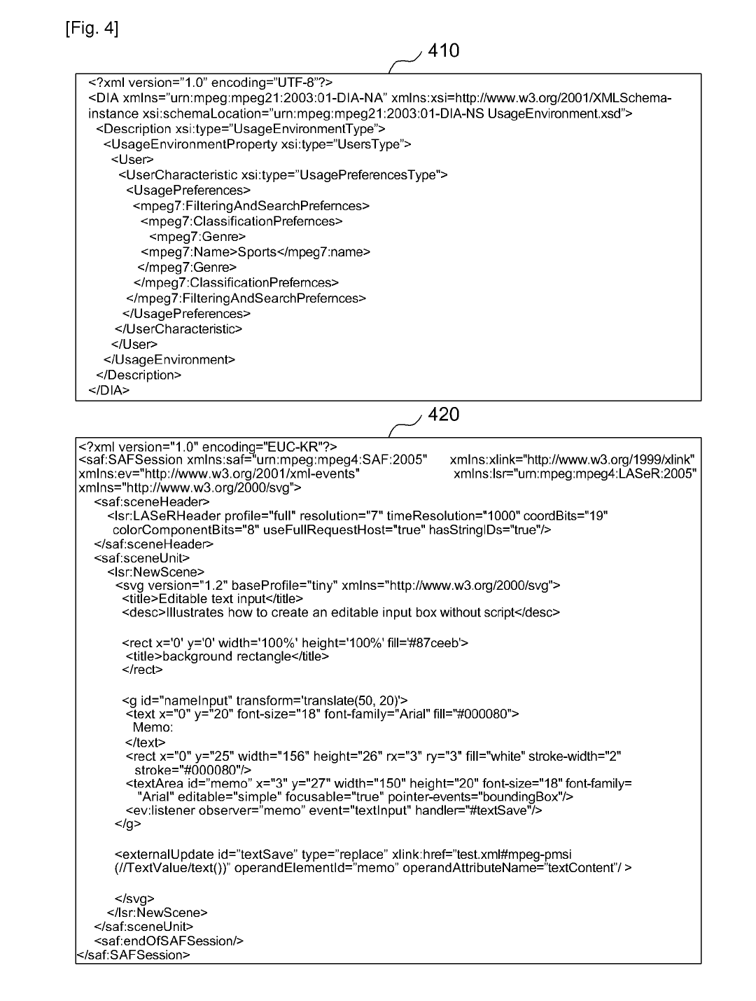

FIG. 4 illustrates source code to insert a predetermined element to an SI according to an embodiment of the present invention.

Referring to FIG. 4, the predetermined element may be inserted to SI 410 based on an “insert” attribute in the PI 420. That is, as illustrated in FIG. 4, an element having a name of a genre corresponding to “movies” may be inserted to the SI 410.

<SVG textArea Element>

### (1) Proposal

When the SI is represented in a Presentation and Modification of Structured Information (PMSI) application, specific textual information existing in XML data is the most commonly referenced. When text wrapping of the referenced information of a given region is allowed, it is significantly convenient for describing textual contents. Here, a “SVG textArea” element is required for convenient wrapping of textual contents within the given region. Also, an “SVG tref” element having an xlink:href attribute is required for retrieving textual contents by referencing.

Here, SVG (Scalable Vector Graphics) is a language based on XML to represent two-dimensional (2D) graphic. A tref (text reference) is used for referencing a text included in the SI, and the SVG indicates how to represent the text referenced through the tref.

Accordingly, an embodiment of the present invention introduces the “SVG tref” element and the “SVG textArea” element. The “SVG tref” element is defined in subclause 10.6 of [W3C SVG11]. Also, SVGT1.2 defines the “SVG textArea” element in subclause 10.11 of [W3C SVGT12]. Text wrapping through the “SVG textArea” element may be lightweight and convenient. The contextual content of “SVG textArea” element can be only actual character data without SVG tref element. Here, the “SVG tref” element may be used as a child element of the “SVG textArea” element.

### (2) Example

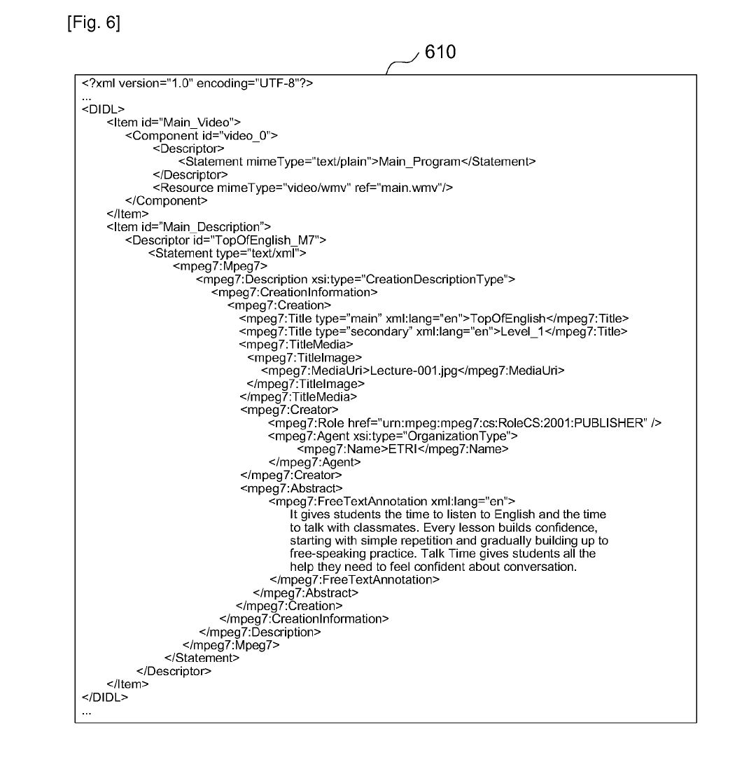

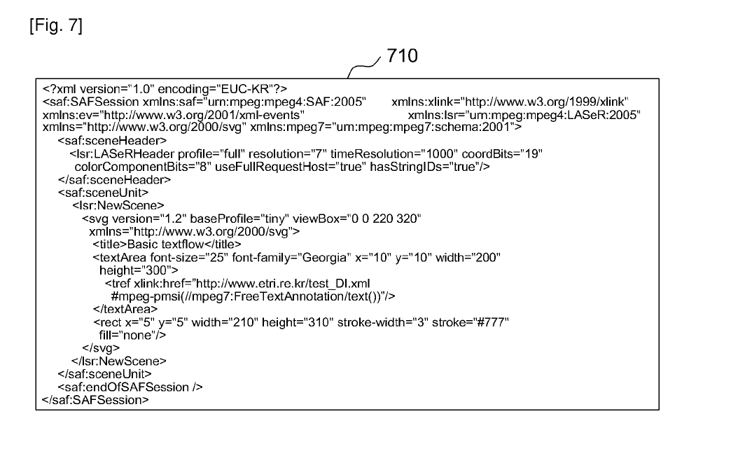

FIGS. 6 and 7 illustrates source code of a PI to determine a character with respect to the text according to an embodiment of the present invention.

Referring to FIGS. 6 and 7, the character of the text in SI 610 may be modified by a “textArea” element of PI 710. Here, the character may include a font-size of the text, a font-family, a location of the text (x, y), a width, a height, and the like. As an example, referring to FIGS. 6 and 7, in the SI 610, the font-size of the text may be set to “25”, the font-family may be set to “Georgia”, the location of the text may be set to x=10 and y=10, the width may be set to “200”, and the height may be set to “300”.

That is, the present embodiment may propose to address a text included in the SI by using the “SVG tref” as a child element of the “SVG textArea”, and to determine the character with respect to the text by using the “SVG textArea” to provide the text wrapping.

However, the PI (scene representation data) may access a fragment of the SI to perform scene representation of the fragment. That is, the scene representation data may address the SI based on a predetermined mpeg-pmsi( ) scheme. Here, the mpeg-pmsi( ) scheme will be described in detail.

<LASeR taref Element>

(1) Proposal and Semantics

An “SVG textArea” element is required for performing wrapping of convenient textual contents within a given region. Also, an “LASeR taref” element including an xlink:href attribute may be required to retrieve textual contents through referencing.

The “LASeR taref” element may be used as a child element of the “SVG textArea” element. An effect of the “LASeR taref” element is similar to an effect of the “SVG tref”

(2) Attribute

The LASeR taref element may include an xlink:href attribute indicating an element or attribute to be referenced.

<mpeg-pmsi( ) Scheme>

(1) An mpeg-pmsi( ) Scheme as a Pointing Scheme for Fragments of the SI

The mpeg-pmsi( ) scheme is intended to be used together with an XPointer framework to address the fragments of the SI under a LASeR namespace.

Also, a process of entities addressed by the mpeg-pmsi( ) scheme may be changed based on a type of a node that uses the mpeg-pmsi( ).

(2) Syntax

The mpeg-pmsi( ) scheme may be defined as an Extended Backus-Naur Form (EBNF) syntax as shown in Table 1 below.

TABLE 1

PointerForStructuredInformation ::=
PointerForStructuredInformationSchemeName “(”
PointerForStructuredInformationSchemeData “)”
PointerForStructuredInformationSchemeName ::= “mpeg-pmsi”

(3) Semantics

PointerforStructuredInformationSchemeData in Table 1 is based on a W3C (World Wide Web Consortium) XPath abbreviated syntax.

Also, the mpeg-pmsi( ) scheme may support an Xpath predicate for filtering out a node-set given from undesired nodes.

As an example, Table 2 as given below indicates representation indicating a ref attribute of a Resource element. Here, the Resource element is a child element of a Component element having a title attribute of a ‘video_{—}1’ value.

TABLE 2

#mpeg-pmsi(Component[@title=‘video_1’]/Resource/@ref))

As described above, the LASeR is a multimedia contents standard and is a scene description format for representing and delivering a rich media service to a device having a limited resources such as a mobile phone. That is, the LASeR is to perform a request from the rich media service in a scene description level.

A decoder model of a LASeR system may include a decoding buffer, an elementary stream, at least one decoder, and a composition unit. The decoder model may decode a decoding buffer that stores data coded for each elementary stream. A result of the decoding may be stored in the composition unit.

As described above, according to an embodiment of the present invention, an update based on information described in the PI and the scene representation based on the SI may mutually operate.

However, a method of updating the SI according to embodiments of the present invention may include extracting information described in the scene representation data and updating SI based on the described information according to a type attribute.

As an example, information described in the scene representation data is extracted through an input of a user and the like, and the SI is updated based on the described information. In this instance, the SI may be updated based on the attribute of the type included in the externalUpdate element supporting the update of the SI. Here, the attribute of the type may include three attributes: “replace”, “insert”, and “delete”.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An updating device of updating structured information, comprising:
updating the structured information according to an attribute of a type.

2. The updating device of claim 1, wherein the updating device updates the structured information based on information described in scene representation data.

3. The updating device of claim 1, wherein the updating device updates the structured information based on an attribute of a type included in an externalUpdate element that supports an update of the structured information.

4. The updating device of claim 3, wherein the externalUpdate element includes an ‘xlink:href’ attribute indicating an element that is replaced, inserted, or deleted by using a mpeg-pmsi( ).

5. The updating device of claim 3, wherein the externalUpdate element includes a ‘type’ attribute indicating one type among a “replace”, “insert”, and “delete”.

6. The updating device of claim 3, wherein the externalUpdate element includes an ‘attributeName’ attribute defining a name of an attribute that is replaced or inserted.

7. The updating device of claim 3, wherein the externalUpdate element includes an ‘index’ attribute defining an index of a child node that is replaced, inserted, or deleted.

8. The updating device of claim 3, wherein the externalUpdate element includes an ‘operandElementId’ element defining an identification (ID) of an element from which a replacement or an insertion is taken.

9. The updating device of claim 3, wherein the externalUpdate element includes an ‘operandAttributeName’ attribute defining a name of attribute from which a replacement or an insertion is taken.

10. The updating device of claim 3, wherein the externalUpdate element includes a ‘value’ attribute indicating a value that is replaced or inserted.

11. The updating device of claim 3, wherein the externalUpdate element includes an lsr:updateInterval attribute setting an update interval of the structured information,
wherein, when a value of the lsr:updateInterval is set to “none”, the structured information is updated once, and when the value of the lsr:updateInterval is set to “free”, the structured information is updated at an arbitrary interval, and when the value of the lsr:updateInterval is a “<Clock-value>” being greater than “0”, the structured information is updated at “<Clock-value>” intervals.

12. The updating device of claim 2, wherein the scene representation data addresses a text included in the structured information by using a SVG tref as a child element of SVG textArea, and determines a character of the text by using the SVG textArea to provide text wrapping.

13. The updating device of claim 12, wherein the scene representation data provides a LASeR taref element that addresses textual contents, as a child element of the SVG textArea element,
wherein the LASeR taref element has an xlink:href attribute indicating a referenced element or a referenced attribute.

14. The updating device of claim 2, wherein the scene representation data may access a fragment of the structured information to perform scene representation of the fragment.

15. The updating device of claim 2, wherein the scene representation data may address the structured information based on a predetermined mpeg-pmsi( ) scheme.

16. The updating device of claim 15, wherein the predetermined mpeg-pmsi( ) scheme is defined according to a syntax of Table 1 below,
TABLE 1
PointerForStructuredInformation ::=
PointerForStructuredInformationSchemeName “(”
PointerForStructuredInformationSchemeData “)”
PointerForStructuredInformationSchemeName ::= “mpeg-pmsi”
wherein, the PointerforStructuredInformationSchemeData is based on an Xpath abbreviated syntax.

17. A method of updating structured information, comprising:
extracting information described in scene representation data; and
updating the structured information based on the described information according to an attribute of a type.

18. The method of claim 17, wherein the updating updates the structured information based on an attribute of a type included in an externalUpdate element supporting the structured information,
wherein the externalUpdate element includes:
an ‘xlink:href’ attribute indicating an element to be replaced, inserted, or deleted by using mpeg-pmsi( );
a ‘type’ attribute defining one type of a replacement, an insertion, and a deletion;
an ‘attributeName’ attribute defining a name of an attribute to be replaced or inserted;
an ‘index’ attribute defining an index of a child node to be replaced, inserted, or deleted;
an ‘operandElementId’ attribute defining an ID of an element from which a replacement or an insertion is taken;
an ‘operandAttributeName’ attribute determining a name of an attribute from which a replacement or an insertion is taken;
a ‘value’ attribute indicating a value to be replaced or inserted; and
an lsr:updateInterval attribute setting an update interval of the structured information.

19. The method of claim 18, wherein,
when a value of the lsr:updateInterval is set to “none”, the lsr:updateInterval attribute updates the structured information once, and when the value of the lsr:updateInterval is set to “free”, the lsr:updateInterval attribute updates the structured information at an arbitrary interval, and when the value of the lsr:updateInterval is a “<Clock-value>” being greater than “0”, the lsr:updateInterval attribute updates the structured information at “<Clock-value>” intervals.

20. The method of claim 17, wherein the scene representation data addresses a text included in the structured information by using a SVG tref as a child element of SVG textArea, and determines a character of the text by using the SVG textArea to provide text wrapping.
